(19) United States
(12) Patent Application Publication
(10) Pub. No.: US 2018/0103064 A1
(43) Pub. Date: Apr. 12, 2018

(54) SYSTEMS AND METHODS FOR DYNAMICALLY DEPLOYING SECURITY PROFILES

(71) Applicant: ShieldX Networks, Inc., San Jose, CA (US)

(72) Inventors: Ratinder Paul Singh AHUJA, Saratoga, CA (US); Manuel NEDBAL, Santa Clara, CA (US); John Thornton PARKER, San Jose, CA (US)

(21) Appl. No.: 15/291,017

(22) Filed: Oct. 11, 2016

(51) Int. Cl. H04L 29/06

(52) U.S. Cl. CPC H04L 63/20; H04L 63/10

(57) ABSTRACT

System, methods, and apparatuses enable a network security system to more efficiently deploy security profiles to virtual servers managed by the network security application. For example, a network security application is enabled to more efficiently deploy security profiles to new virtual servers as the virtual servers are created in a computing environment, where the new virtual servers may have varying security requirements. A security profile herein refers to a set of security policy configurations related to various functions of a virtual server including, for example, to which networks a virtual server is permitted to access, security configurations for applications running on the virtual server, user permissions, etc.

### TECHNICAL FIELD

Embodiments relate generally to computer network security. More specifically, embodiments relate to techniques for dynamically deploying security profiles to virtual servers and other computing resources.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The security of computing devices against internal and external threats including viruses, malware, network intrusions, etc., is a concern in virtually all networked computing environments. To protect computing devices against such threats, networked computing devices typically are configured with various security settings to prevent unwanted behavior. Examples of security settings that might be applied to computing devices include restricting or permitting access by the computing devices to particular networks, defining particular types of permitted network traffic, configuring permissions with respect to particular applications, configuring user permissions and restrictions, and so forth.

As illustrated above, protecting a computing device against security threats often involves configuring a large number of security settings. To increase the speed with which security settings can be configured as new computing devices are added to a network, some systems administrators and other users may create one or more “security profiles” for automatically configuring devices. At a high level, a security profile comprises a set of preconfigured security settings which can be deployed to any number of computing devices, thereby automating some of the manual security configuration process each time. However, modern data centers often include many different types of servers each with different sets of security requirements, and manually selecting and deploying an appropriate security profile each time a new server is created in such environments can quickly become a cumbersome and time-consuming effort.

### BRIEF DESCRIPTION OF THE DRAWINGS

In the drawings:

FIG. 1 is a block diagram illustrating computer hardware for loading network security system microservices from a memory and executing them by a processor in accordance with the disclosed embodiments;

FIG. 2 illustrates an embodiment of a scalable security architecture implementing a three-time scale out using security microservices in accordance with the disclosed embodiments;

FIG. 3 illustrates an arbitrary scaling out of a microservice in accordance with the disclosed embodiments;

FIG. 4 is a block diagram illustrating a security service configured to monitor traffic sent among an application and one or more servers through a routing network in accordance with the disclosed embodiments;

FIG. 5 is a block flow diagram illustrating application data traversing to a server after passing through a hierarchy of security microservices in accordance with the disclosed embodiments;

FIG. 6 is a block flow diagram illustrating an embodiment of a flow of application data through a stateless processing fault-tolerant microservice environment in accordance with the disclosed embodiments;

FIG. 7 is a block diagram illustrating components of a security policy configuration microservice in accordance with the disclosed embodiments;

FIG. 8 is a block diagram illustrating an example server properties database in accordance with the disclosed embodiments;

FIG. 9 is a block diagram illustrating an example of a security policy database in accordance with the disclosed embodiments;

FIG. 10A is a flow diagram illustrating an example process for profiling a population of servers of a computing environment in accordance with the disclosed embodiments;

FIG. 10B is a flow diagram illustrating an example process for deploying a selected security profile to newly created servers in accordance with the disclosed embodiments; and

FIG. 11 illustrates a computer system upon which an embodiment may be implemented.

### DETAILED DESCRIPTION

In the following description, for the purposes of explanation, numerous specific details are set forth in order to provide a thorough understanding of embodiments of the present invention. It will be apparent, however, that embodiments of the present invention may be practiced without these specific details. In other instances, well-known structures and devices are shown in block diagram form in order to avoid unnecessarily obscuring embodiments of the present invention.

References in the specification to “one embodiment,” “an embodiment,” “an example embodiment,” etc., indicate that the embodiment described may include a particular feature, structure, or characteristic, but every embodiment need not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments are described herein according to the following outline:
1.0. General Overview
2.0. Operating Environment
   2.1. System Overview
   2.2. Security Policy Configuration Microservices
3.0. Functional Overview
   3.1. Security Policy Profiles Overview
   3.2. Dynamically Selecting and Deploying Security Policy Profiles
4.0. Example Embodiments
5.0. Implementation Mechanism—Hardware Overview
6.0. Extensions and Alternatives

### 1.0. GENERAL OVERVIEW

Modern data centers and other computing environments can include anywhere from a few computer systems to thousands of systems configured to process data, service requests from remote clients and other applications, and perform numerous other computational tasks. The large number of interworking systems, applications, etc., make such computing environments susceptible to a wide variety of network security issues. A number of network security tools are available to protect such systems and the computer networks interconnecting these systems, and many of these tools comprise a monolithic set of network security functions. For example, a typical network security tool might comprise a hardware unit including firewall services, routing services, virtual private network (VPN) services, and so forth.

The type of network security tool described above is useful for providing a variety of network security functions as a single unit. However, efficiently scaling these types of network security tools is often challenging. For example, if a particular computer environment might benefit from increased firewall resources, a system administrator may install one or more additional hardware units each including firewall services in addition to a suite of other network security functions. While the addition of these new hardware units may meet the increased firewall resource needs, some of the hardware units may include unnecessary and/or underutilized resources devoted to virtual private network (VPN) services, data loss prevention (DLP) services, or other security services.

One way in which many modern computing environments scale resources more efficiently is using virtualized computing resources. A virtualized computing resource generally refers to an abstracted physical computing resource presented to an operating system and its applications by means of a hypervisor such that the virtual computing resources (compute, memory, network connectivity, storage, etc.) are configurable and may be different from those of the physical computing resource. According to one embodiment, these types of virtualized infrastructures are used to efficiently scale network security applications based on the use of “microservices,” where a microservice is a particular type of virtualized computing resource packaged as a software container. For example, a network security platform may comprise separate microservices providing firewall resources, DLP services, VPN services, etc. In general, the use of such microservices can provide greater flexibility because the microservices can be more easily deployed and scaled in response to variable demands for various types of network security services.

The type of efficient network security application scaling described above can be achieved with the use of a security application that is configured to scale network security services using microservices. Although many of the techniques described herein are explained with reference to a microservice-based network security application, the techniques are also applicable to other types of network security systems.

### 2.0. OPERATING ENVIRONMENT

2.1. System Overview

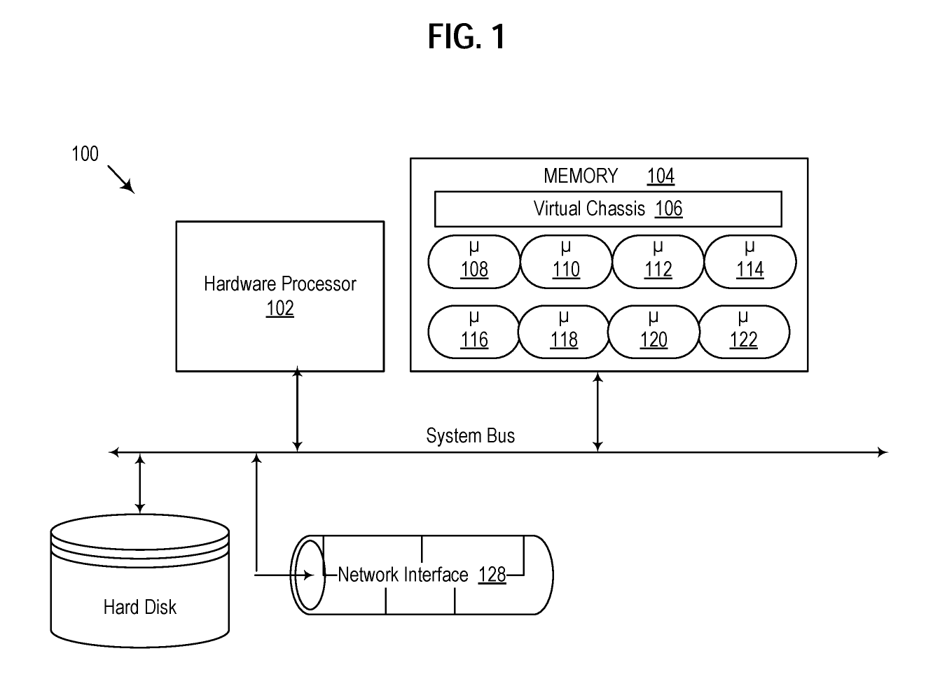

FIG. 1 is a block diagram illustrating an embodiment of a scalable microservice architecture using microservices. Network security system microservices 108-122 are stored in memory 104 (e.g., volatile memory such as Random Access Memory (RAM) and/or non-volatile memory such as disk) and executed by one or more hardware processors or processor cores 102. Network security system microservices 108-122, consisting of computer-executable instructions to perform a specific security service, are deployed based on configuration across available physical servers. Typically, each microservice receives a configuration and tasks via a backplane of a virtual chassis 106 and returns status, statistics, and other information to the backplane.

The data processed by the network security system 100 is transferred from a microservice to another (higher hierarchy) microservice using a data plane. In some embodiments, during such a transfer, a lower microservice makes a decision (based on configuration, current statistics and other information) as to which higher in the hierarchy microservice to utilize. Such a decision may constitute a load-balancing decision to assure that the higher-hierarchy microservices are efficiently utilized. In other embodiments, the decision of which microservice to utilize is made by a more central entity.

As illustrated, a network security system 100 utilizes a hardware processor 102 (such as a central processing unit (CPU) or one or more cores thereof, a graphics processing unit (GPU) or one or more cores thereof, or an accelerated processing unit (APU) or one or more cores thereof) to execute microservices stored in memory 104 (e.g., volatile memory such as Random Access Memory (RAM) and/or non-volatile memory such as disk). A network interface 128 (e.g., fabric or interconnect that is wired or wireless) provides a means for communicating with a data center. Network security system 100 may inspect traffic, detect threats, and otherwise protects a data center using the microservices 108-122.

Embodiments of a network security system 100 providing the above capabilities are now discussed in more detail. Network security system 100 adds security to, or enhances the security of, a datacenter or other computing environment. In an embodiment, network security system 100 is delivered in the form of a seed software application (e.g., downloaded). The seed software application instantiates microservices of the network security system on a host in the datacenter. As used herein, a microservice container refers to where the microservice runs, for example, on a virtual machine. Once deployed, network security system 100 utilizes a hardware processor 102 (as detailed above), memory 104, and network interface 128. In many scenarios, security may be added/configured using existing hardware and/or without purchasing additional rack devices for particular functionality. The seed software application may be installed on any one of a wide variety of hosts—be they slow or fast, low-cost or high-cost, commodity or customized, geographically dispersed, part of a redundancy scheme, or part of a system with regular back-ups.

In some embodiments, a network security system 100 utilizes a network interface 128 to explore the datacenter and to discover existing network segments, determine security settings to apply to various network segments, detect available hosts and hardware resources, and determine additional configuration information as needed. In an embodiment, the datacenter itself includes several machines with hypervisors, or physical hardware, and the network security system 100 offers microservices to communicate with and protect one or more of those internal virtual machines or physical hardware. Based on performing datacenter discovery, a network security system 100, in some embodiments, may then offer or suggest available security tools for selection either through a graphical interface or via connections with existing enterprise management software. In one embodiment, once configured, a network security system 100 is deployed “in-line,” receiving packets headed for the datacenter, thereby allowing network security system to intercept and block suspicious traffic before it reaches the datacenter. With an understanding of the datacenter, a network security system 100 deploys microservices to inspect traffic throughout the datacenter, and not only at ingress. In some embodiments, a network security system 100 is deployed in a “copy only” configuration, in which the system monitors traffic, detects threats, and generates alerts, but does not intercept traffic before it arrives at the datacenter.

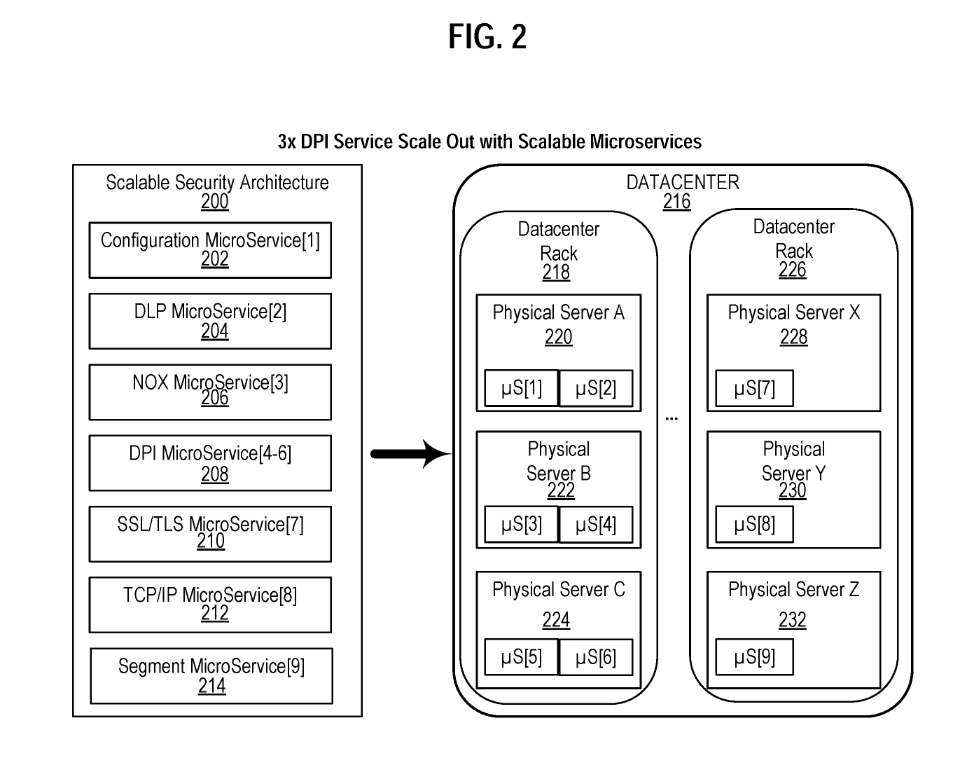

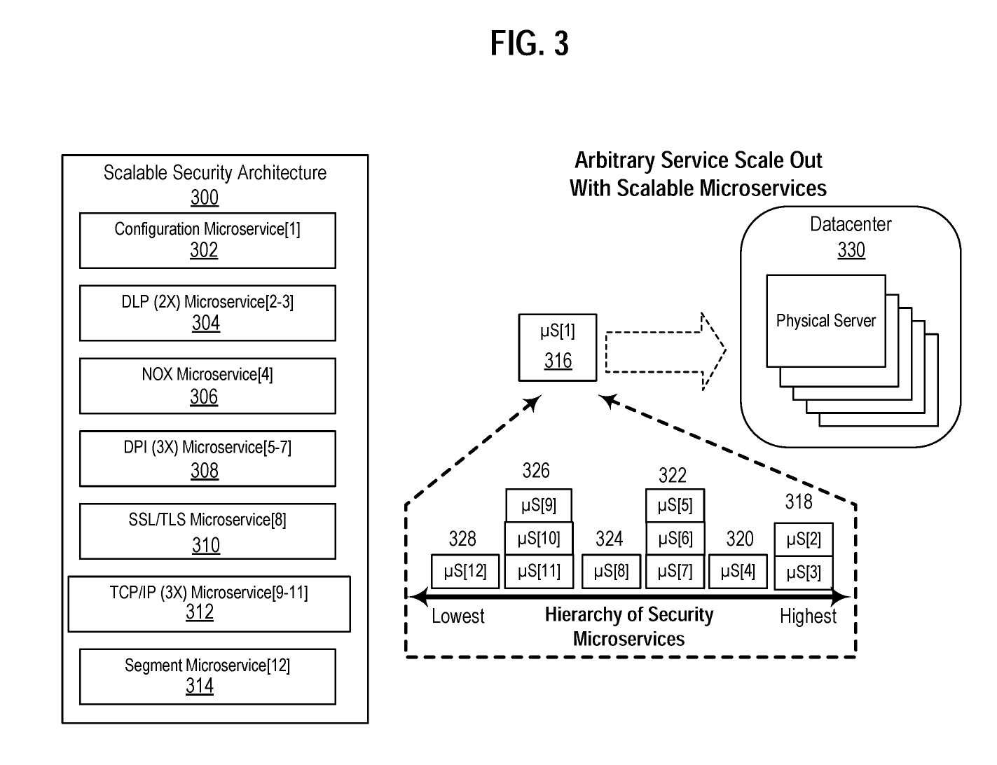

As shown, memory 104 has stored therein microservices 108, 110, 112, 114, 116, 118, 120, and 122 (108-122), as well as a virtual chassis 106, which is also a microservice. In an embodiment, the microservices are small in size, consisting of a relatively small number of instructions. In an embodiment, the microservices 108-122 are independent of each other. As illustrated, microservices 108-122 are microservices that are loaded from memory and executed by the hardware processor 102. Those microservices 108-122 include data path security microservices, for example TCP/IP, SSL, DPI, or DLP microservices, as described further below with respect to FIGS. 2 and 3. The microservices 108-122 may also include management microservices, for example, a chassis controller to manage the microservices, a configuration microservice, an infrastructure discovery microservice, a database microservice to store data, a policy update microservice to receive policy updates from an external security cloud, and a compiler to receive policy data from various sources and to produce binary policy outputs to be used by the microservices, to name a few examples that are described hereinafter with respect to FIGS. 2 and 3.

In an embodiment, a network security system 100 receives traffic via network interface 128 to/from a datacenter. In one embodiment, a network security system 100 is placed in-line to inspect traffic, and potentially intercept a threat before it arrives at, or leaves, the datacenter. In other embodiments, a network security system 100 monitors the traffic heading into, or out of, the datacenter, in which case the network security system 100 detects threats and generates alerts, but does not block the data. A hardware processor 102 may execute various data security microservices on the data. For example, as described hereinafter with respect to FIGS. 2 and 3, typically traffic first passes into and through a segment microservice, then a TCP/IP inspection microservice, then a SSL microservice, then a DPI microservice, then a NOX microservice, and then a DLP microservice. However, one or more of these services may not be enabled. In some embodiments, a segment microservice resides within a network segment and serves as the entry point for data packets and forwards the packets to appropriate microservices for further analysis. Data path microservices as used herein refer to various microservices that inspect and analyze network traffic, such as TCP, TLS, DPI, NOX, and DLP microservices. A TCP microservice, for example, refers to a packet handling microservice able to process any layer 4-6 network packet and includes part of firewalling. A TLS microservice, for example, refers to a Transport Layer Security microservice, which decrypts/re-encrypts connections. A DPI microservice, for example, refers to a Deep Packet Inspection microservice and handles layer 7 inspection. A NOX microservice, for example, refers to a Network Object Extractor microservice, and works in conjunction with DPI to assemble objects from individual packets and to deliver the objects to other services. A DLP microservice, for example, refers to a Data Loss Prevention microservice, which detects and attempts to prevent data loss. Control path microservices, on the other hand, are various microservices, such as a factory, a compiler, a configuration, an infrastructure discovery, a database, a messenger, a scaler, and a chassis controller, that are instantiated in, and make up, a management plane. Threats detected by the aforementioned microservices will, in one embodiment, be reported to a chassis controller microservice, which takes remedial action.

In an embodiment, microservices 108-122 are implemented using computer-executable instructions loaded from the Internet, via network interface 128. For instance, in an embodiment, the microservices are implemented with computer-executable instructions downloaded from a web site or online store site. In some embodiments, microservices 108-122 are loaded into memory 104. In various embodiments, the microservices are implemented using computer-executable instructions loaded on and received from a non-transitory computer readable medium, such as digital media, including another disc drive, a CD, a CDROM, a DVD, a USB flash drives, a Flash memory, a Secure Digital (SD) memory card, a memory card, without limitation. Microservices received from a digital medium in one instance are stored into memory 104. The embodiments are not limited in this context. In further embodiments, a digital medium is a data source that constitutes a combination of hardware elements such as a processor and memory.

In most embodiments, network security system runs on a datacenter computer. In alternate embodiments, however, network security system is installed and runs on any one of a wide variety of alternate computing platforms, ranging from low-cost to high-cost, and from low-power to high power. In some embodiments, network security system is installed on and runs on a low-cost, commodity server computer, or, in some embodiments, on a low-cost rack-mounted server. As illustrated, hardware processor 102 is a single core processor. In alternate embodiments, hardware processor 102 is a multi-core processor. In alternate embodiments, hardware processor 102 is a massively parallel processor. In some embodiments, a virtual chassis 106 and microservices 108-122 may be hosted on any of a wide variety of hardware platforms used in the datacenter to be protected.

In some embodiments, a network security system 100 scales out using available resources to accommodate higher traffic or load. In one embodiment, hardware processor 102 (CPU) and memory 104 are scaled out or in dynamically as needed: additional CPUs and memory are added if scaling out, and some CPUs and/or memory are powered down if scaling in. This scaling out is performed to allocate the additional CPUs and memory to those portions of the security hierarchy for which there is demand, while not allocating additional CPUs and memory to those portions of the security hierarchy that can accommodate the higher traffic utilizing their existing allocation.

A common property of a microservice is the separation and protection of memory from other microservices. In this manner, an individual microservice may be moved to another physical server or terminate abnormally without impacting other microservices. Microservices may be distinguished from threads in that threads generally operate within a shared memory space and exist within the confines of the operating system on which they were spawned.

FIG. 2 illustrates a three-time scale out, according to an embodiment, using microservices. In the example of FIG. 2, only a single microservice (e.g., a DPI microservice) has a demand for additional resources. As shown, by utilizing a scalable microservice architecture 200, including DLP microservice 204, NOX microservice 206, DPI microservice 208, SSL/TLS microservice 210, TCP/IP microservice 212, and segment microservice 214, each layer of the security service hierarchy can be scaled and configured independently to load balance the supply of processed data to the next hierarchy level. As shown, datacenter 216 includes datacenter rack 218, which includes physical server A 220, physical server B 222, and physical server C 224. As shown, a datacenter rack 226 includes physical server X 228, physical server Y 230, and physical server Z 232. DPI microservices 208 have been scaled out 3X, and in this instance assigned to be performed as microservices 4-to-6 on physical server B 222 and physical server C 224. The remaining microservices of scalable security architecture are shown as being implemented by physical servers A, X, Y, and Z (220, 228, 230, and 232, respectively). A configuration microservice 202 creates a configuration backplane and a data plane deployed as a software component on each physical server that is to receive security services. This creating process takes the form of configuring routing rules, reserving network address space (such as a subnet) and configuring virtual environments to utilize portions of the reserved address space as gateways for network communication in and out of the servers to be secured. Both the backplane and data plane may thus be considered virtual networks managed by the security system. All security microservices may then utilize these networks to transmit packets, content, state and other information among themselves. The properties of the backplane and data plane are configured to reject packet traffic from outside the security system and to route information between microservices regardless of the physical server and virtual environment configuration.

FIG. 3 illustrates an arbitrary scale-out according to an embodiment. As shown, scalable security architecture 300 includes configuration microservice 302, DLP (2X) microservice 304 (a 2-times scale-out), NOX microservice 306, DPI (3X) microservice 308 (a 3-times scale-out), SSL/TLS microservice 310, TCP/IP (3X) microservice 312 (a 3-times scale-out), and segment microservice 314. As shown, configuration microservice 316, provisions (318, 320, 322, 324, 326, and 328) the 11 microservices from a lowest hierarchy to a highest hierarchy, and configures them to communicate with each other via a backplane. The microservices, for example, may be implemented by physical servers in datacenter 330.

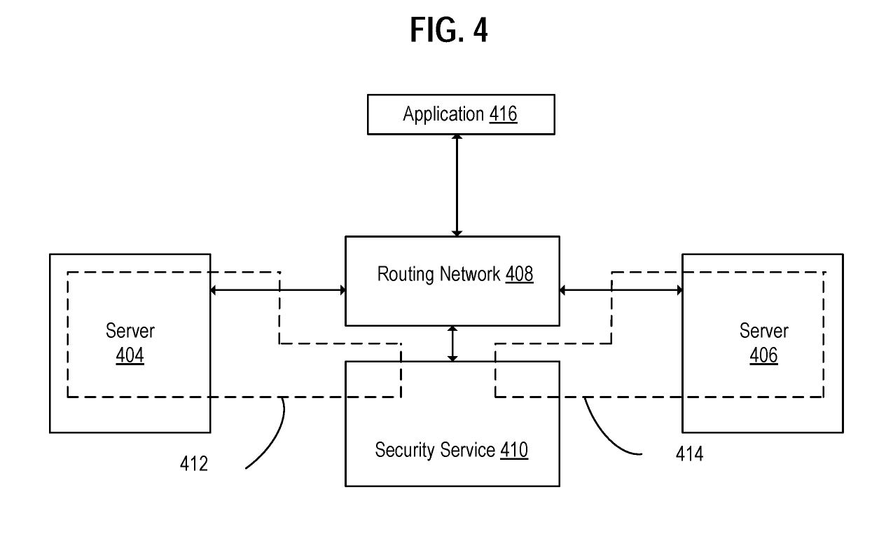

FIG. 4 is a block diagram illustrating a networked computer environment in which an embodiment may be implemented. FIG. 4 represents an example embodiment that is provided for purposes of illustrating a clear example; other embodiments may use different arrangements.

The networked computer system depicted in FIG. 4 comprises one or more computing devices. These one or more computing devices comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

In one embodiment, one or more security services 410 may be configured to monitor network traffic and other data sent between an application 416 and one or more servers 404, 406 through a routing network 408. The security service 410 comprises one or more “microservices” used to monitor and perform various actions relative to data items (e.g. network traffic, files, email messages, etc.) sent to and received from one or more applications 416 and servers 404, 406. The microservices comprising security service 410 do not need to be confined to one physical server such as a server 404, 406. For example, one or more microservices of the security service 410 may be executed on server 404 and other microservices of the security service 410 are executed on server 406. In some embodiments, the security service 410 is executed on a different server from one or more servers for which the security service is responsible for monitoring and protecting.

In an embodiment, a routing network 408 provides connectivity among servers 404, 406, security service 410, and application 416. In some embodiments, routing network 408 is partially configured responsive to hypervisor configuration of servers 404 and 406. In some embodiments, a routing network 408 is partially or entirely configured responsive to hypervisor configuration of servers 404 and/or 406.

In one embodiment, by virtue of routing information included in channel data encapsulation packets, data traveling between an application 416 and server 404 and/or server 406 is routed to the correct server, and is kept separate from data traveling between the application 416 and the other server. Accordingly, what is essentially a private network 412 may be created between the server running security service 410 and server 404. Similarly, what is essentially a private network 414 may be created between the server running security service 410 and server 406.

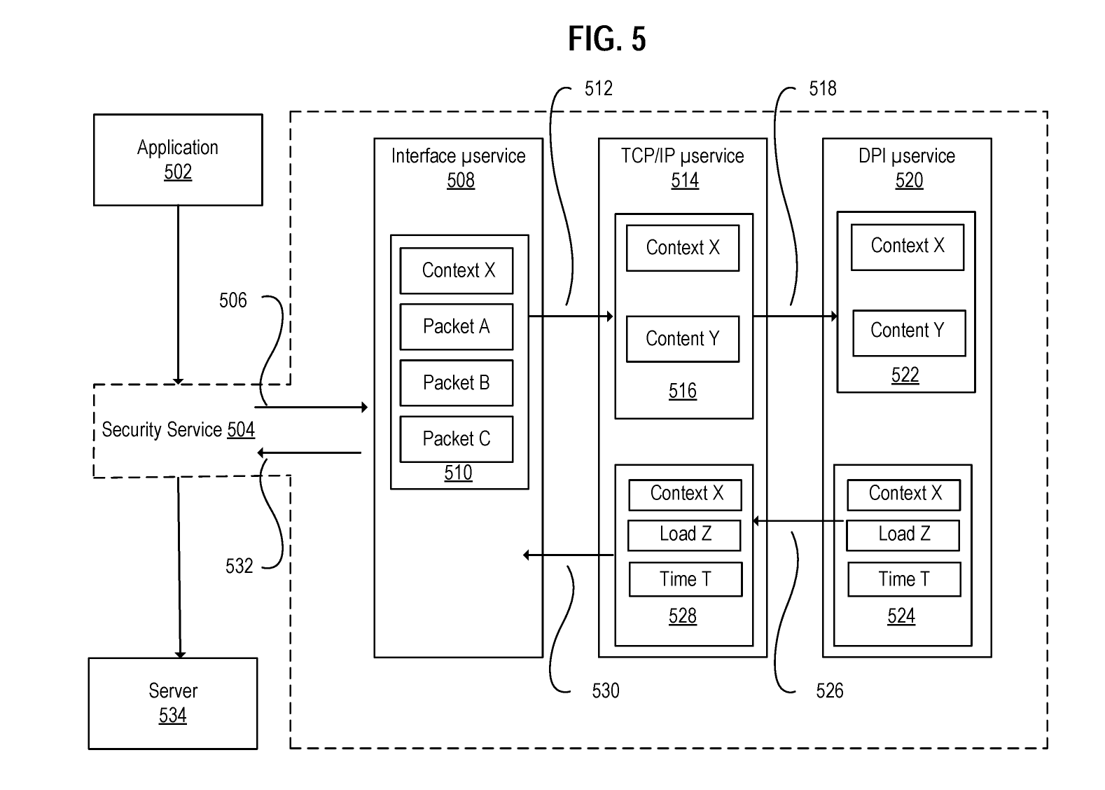

FIG. 5 is a block flow diagram illustrating application data traversing to a server after passing through a hierarchy of a security microservices according to an embodiment. As illustrated, the flow begins with security service 504 receiving a network data packet from application 502. Security service 504 forwards 506 the packet to interface microservice 508, which generates a channel data encapsulation packet 510, which encapsulates three packets A, B, and C, and context X. As shown, channel data encapsulation packet 510 encapsulates three packets, but in alternate embodiments, the number of encapsulated packets may vary without limitation. In some embodiments, context X is generated based at least on the headers of packets A, B and C. In some embodiments, context X is generated based on a lookup of packet header fields such as IP addresses, ports, and MAC addresses for the source and/or destination of the packets. In some embodiments, the generation of context X includes using an interface identifier obtained from a virtualization environment. Generation of context X may be accomplished through a lookup of header fields and other data in a table, a hash of header fields and other data, or another method whereby packets for which a common security policy is to be applied are associated with a common context or common portion, such as a bit field, of the context.

Context X may be considered an identifier describing the traffic streams, source machines or applications responsible for generating packets A, B and C. This identifier may be direct (such as an ID used as a table look up), indirect (such as a pointer used to access a data structure), or some other method of instructing microservices as to the policies and processing to use for handling packets A, B and C. As an example, context X may be generated by performing a hash, longest prefix match or lookup of header fields such as IP addresses, TCP ports, interface names (or MAC addresses), or other packet properties. The lookup may be an exact match, longest prefix match, or other method to associate packet streams with the same security processing to use. The generated context may then be used by security services, such as a DPI service, to determine which rules should be utilized when scanning the data from packets A, B and C (and other packets that are part of the same traffic stream). This information may be embedded within the context (as a bit field or other information), available by indirection (such as a table or data structure lookup by another service), or generated programmatically based on any combination of such information.

The context may be generated through a look up at an interface microservice and is included in the transmission of packet data to transmission control protocol (TCP) reassembly services. Reassembled content from the TCP microservice is transmitted to a deep packet inspection (DPI) microservice or secure socket layer (SSL) microservice, and with the same context. By maintaining this context in the encapsulation of data transport throughout the microservice hierarchy, processing directives associated with a context become a shared read-only resource (relative to the microservices) that only rarely use stateful updates.

Interface microservice 508 transmits 512 the channel data encapsulation packet 510 to TCP/IP microservice 514. As shown, the channel data encapsulation packet 516 includes context X and content Y, which corresponds to packets A, B, and C of channel data encapsulation packet 510. After conducting security processing of the channel data encapsulation packet 516, TCP/IP microservice 514 transmits 518 the packet to DPI microservice 520. As shown, the channel data encapsulation packet 522 includes context X and content Y, which corresponds to packets A, B, and C of channel data encapsulation packet 510. After conducting security processing of the channel data encapsulation packet 522, DPI microservice 520 generates channel data encapsulation packet 24, which, as shown, includes context X, DPI load Z, and DPI timestamp T. Encapsulated channel data may be tagged with properties including a timestamp and a load metric. The timestamp may reference the duration of microservice processing, the time at which microservice processing started or another temporal property associated with processing the encapsulated channel data. The load metric may reference the relative or absolute loading of a microservice processing the encapsulated channel data.

As shown, a DPI microservice 520 transmits, via path 526, channel data encapsulation packet 524 to TCP/IP microservice 514, which uses the DPI load and DPI timestamp information to inform future load-balancing decisions. As shown, a TCP/IP microservice 514 generates channel data encapsulation packet 528, which includes context X, TCPI/IP load Z, and TCP/IP timestamp T. As shown, TCP/IP microservice 514 transmits, via path 530, channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits them to server 534.

As shown, DPI microservice 520 transmits channel data encapsulation packet 524 to TCP/IP microservice 514, which uses the DPI load and DPI timestamp information to inform future load-balancing decisions. As shown, TCP/IP microservice 514 generates channel data encapsulation packet 528, which includes context X, TCP/IP load Z, and TCP/IP timestamp T. As shown, TCP/IP microservice 514 transmits channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits them to server 534 microservice

Exemplary benefits of the security service 504 may include the ability of each microservice to utilize the same channel data encapsulation protocol for all communication, thereby allowing scaling across the entirety of the datacenter network routable via the channel data encapsulation header. Communications between microservices maintain Context X generated at interface microservice 508 to all subsequent microservices that no longer have access to the original packets. By providing load and timestamp data in the channel data encapsulation packets 524 and 528, which are returned via paths 526 and 530, the microservices receive and can maintain real-time loading and processing latency information utilized to make load balancing decisions.

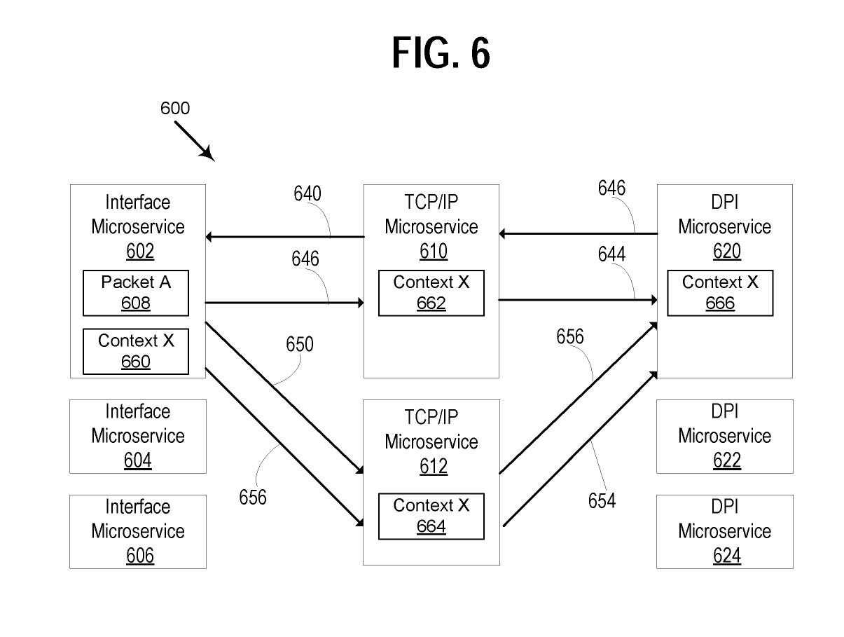

FIG. 6 is a block diagram illustrating a flow of application data through a stateless processing, fault-tolerant microservice environment in accordance with disclosed embodiments. As illustrated, security system 600 includes interface microservices 602, 604, and 606, TCP/IP microservices 610 and 612, and DPI microservices 620, 622, and 624. Other examples include a different number of microservices and/or a different number of microservice types. In the example of FIG. 6, an interface microservice 602 receives packet A 608, and generates a context X 660.

One benefit of the security system illustrated in FIG. 6 is the handling of state. For example, if packets belong to a certain context X, the security system 600 may enable both TCP/IP microservices 610 and 612 to perform meaningful work on the packets. By implementing TCP/IP processing as microservices 610 and 612 with an external state structure and a context that accompanies processed data, each TCP/IP microservice, and any other microservice at every level of the security hierarchy, can be isolated from other microservices and can be scaled independently. Each microservice can access the state for any packet or reassembled packet data, thereby enabling real-time load balancing. In many cases, the context enables microservices to forego consulting service state (state associated with processing at the hierarchy level of the specific microservice), thereby reducing the demands on the global state repository.

As an example, consider the context X 662 obtained by TCP/IP microservice 610 as part of packets received from interface microservice 602 as transmission 640. Context X 662, when transmitted to DPI microservice 620 as part of transmission 642, along with the reassembled packet data, contains information that may enable the DPI microservice to forego or simplify processing of this reassembled data. Such information can include, for example, a context bit or field specifying a subset of regular expressions or patterns to be used for DPI processing, a number of bytes of reassembled data to be received before beginning DPI processing, specific allowed or disallowed protocols, and other information potentially avoiding a DPI state lookup.

In an embodiment, microservices of a security system 600 are stateless. For example, each of the microservices may retrieve state information from an outside source such that the microservice can process packets or content belonging to any context. Each microservice may retrieve and update service state (that state associated with the microservice processing). Additionally, each microservice may retrieve and update context state (state associated with the context relevant for all security service processing). In some embodiments, the process state and context state share a global state service. Examples of elements of context state include a level of suspicion regarding traffic from a source IP, a policy to ignore certain ports or protocols and other information used to process the packets, reassembled content, and extracted objects from communication identified with the context.

In an embodiment, multiple microservices in the same or different hierarchy of the security system may be able to process packets associated with the same context at the same time. If one security microservice fails (e.g., if a TCP microservice fails to respond to a request), another microservice can take over and process the request using the failed microservice's context.

Returning to FIG. 6, the generation of context X 660 may include considering properties associated with packet A 608 (e.g., such as an n-tuple detailing routing information), and also a state lookup or a context lookup, in addition to other information. Interface microservice 602 provides packet A 608 and context X 660 to TCP/IP microservice 610 or 612 via path 640 or 650, respectively. For example, interface microservice 602 may conduct a load-balancing to select one of the TCIP/IP microservices to forward the packet A 608 and the context X 660.

In an embodiment, TCP/IP microservices 610 and 612 are stateless, but may benefit from the context X generation performed by interface microservice 602. For example, whichever of TCP/IP microservices 610 and 612 receives packet A may disassemble the packet to extract the data associated with the packet and conduct security processing on the data. TCP/IP reassembly generally consists of associating packets with flows (e.g., identified by source and destination IP and port values) and using the TCP sequence numbering to place the packets into a correct order, remove any overlap or duplication, and/or identify missing or out of order packets.

In FIG. 6, TCP/IP microservices 610 or 612 forward the extracted data and/or the data resulting from the security processing to DPI microservice 620 via paths 642 or 652, respectively. Along with the transmitted data, TCP/IP microservice 610 or 612 forwards context X 662 or 664, respectively, to a DPI microservice 620. In some embodiments, context X 660, 662, 664, and 666 are substantially identical.

In an embodiment, DPI microservice 620 is also stateless and may use the context provided by TCP/IP microservice 610 or 612 in transmission 642 or 652. DPI microservice 620 may load DPI processing state before processing the received data, but can perform some work (e.g., scheduling different DPI pattern state tables) based on the context. Transmitting the context to the DPI microservice therefore may obviate some amount of work by the DPI microservice. If TCP/IP microservice 610 fails and interface microservice 602 instead utilizes TCP/IP microservice 612, DPI microservice 620 may obtain the context from the transmission of reassembled TCP content in transmission 652.

Although FIG. 6 does not show a second packet, when a subsequent packet associated with the same context is received, interface microservice 602 may conduct a load balancing and select one of the TCP/IP microservices to forward the packet along with context X 660. In one embodiment, interface microservice 602 chooses to forward the second packet to TCP/IP microservice 612 via path 650. TCP/IP microservice 612 performs some security processing, then transmits the second packet and context X 664 to DPI microservice 620 via path 652. After performing some security processing, DPI microservice 620 responds to TCP/IP microservice 612 via path 654, and TCP/IP microservice responds to interface microservice 602 via path 656.

Summarizing the operation of an embodiment as illustrated by FIG. 6, an interface microservice transmits packets to a TCP/IP microservice along with a context that has been generated based on the contents of the packets. The transmission comprises a request to perform a security service (e.g., TCP/IP reassembly) for the packets to generate reassembled data. The TCP/IP microservice consults the received context to determine whether to obtain a context state, service state, or both, from a state repository to perform the security service. Reassembly is performed by the TCP/IP microservice, any modified state returned to the state repository and the reassembled data transmitted, along with the context, to a DPI microservice as a request to perform DPI processing.

Continuing the example illustrated by FIG. 6, the DPI microservice receives the reassembled data and context from the request to perform DPI security services transmitted by the TCP/IP microservice. The DPI microservice consults the received context to determine whether to obtain a context state, service state, or both, from a state repository to perform its security service. DPI inspection may be performed by the DPI microservice, any modified state returned to the state repository, and a response sent to the TCP/IP microservice.

2.2. Security Policy Configuration Microservices

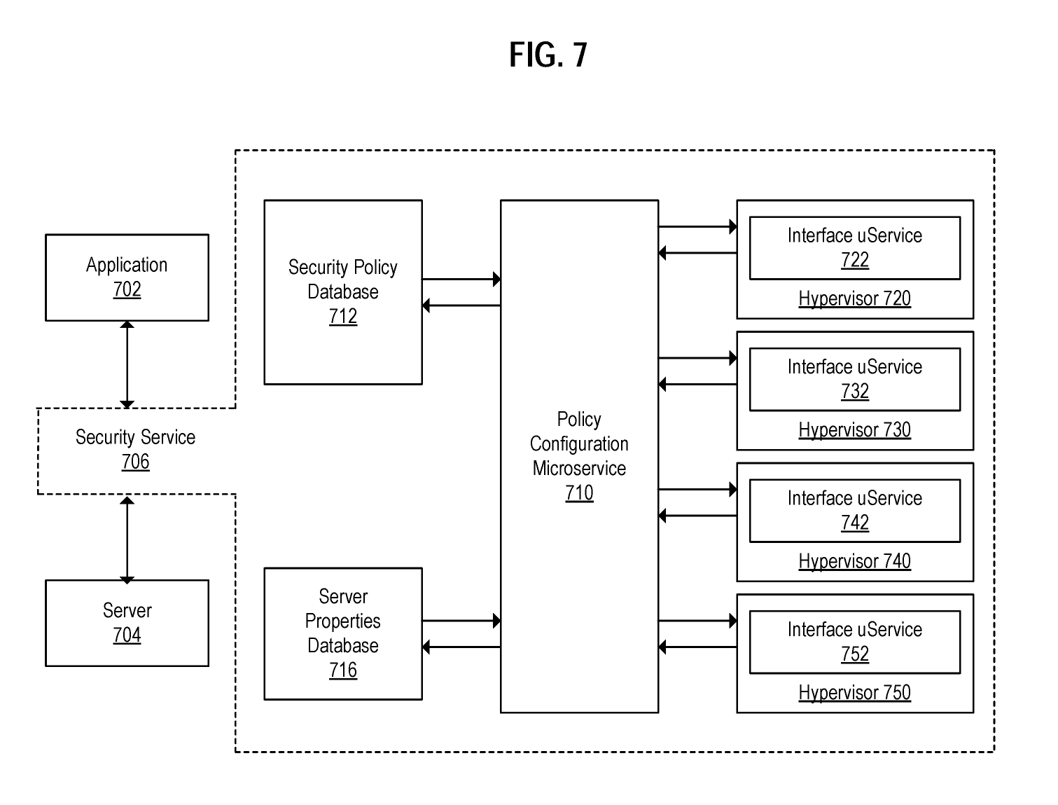

FIG. 7 is a block diagram including an embodiment of a security service. In an embodiment, a security service 706 comprises a plurality of microservices, including a policy configuration microservice 710 and interface microservices 722, 732, 742, and 752, where each of the interface microservices is running on one of hypervisors 720, 730, 740 and 750. In an embodiment, a security service 706 further includes a security policy database 712 and a server properties database 716. FIG. 7 represents an embodiment that is provided for purposes of illustrating a clear example; other embodiments may use different arrangements.

In an embodiment, a policy configuration microservice 710 is configured to generate and store server profile data for a population of virtual servers in a computing environment, to determine a security policy to apply to newly created virtual servers based on the stored existing server profile data, and to deploy selected security policies to the new virtual servers, among other functions. For example, a policy configuration microservice 710 may generate profile data for virtual servers running on hypervisors 720-752 and store the generated profile data in a server properties database 716. As described in more detail herein, the policy configuration microservice 710 may receive indications of new virtual servers, compare property information associated with the new virtual servers against the server profile data stored in a server properties database 716, and select a security profile to apply to the new virtual server from a security policy database 712 based on determining a security profile associated with one or more existing virtual servers which is most similar to the new virtual server.

In an embodiment, a security policy database 712 stores a set of security policy profiles. For example, each security policy profile may include data specifying one or more security policy configurations, rules, parameters, etc., to be applied to a virtual server. For example, a security policy profile may specify rules relating to accessible networks, application permissions, user permissions, encryption policies, data loss prevention policies, etc. Each security policy profile may be stored as a file, a collection of data entries in a table, or in any other format or combinations thereof.

In an embodiment, a server properties database 716 stores property information related to virtual servers and associated hypervisors monitored by a security service 706. For example, a server properties database 716 may store property information for a plurality of hypervisors 720, 730, 740 and 750 and any virtual servers running under the hypervisors. In other embodiments, a server properties database 716 may store property information for components outside of the system (e.g., corresponding to default or industry standard server property configurations). Example of property information that may be stored in a server properties database 716 includes, but is not limited to, server names, server addresses, hypervisor types, networks to which the server is permitted to access, applications running on the server, an operating system and version running on the server, security patch status of the server, security policy settings, etc. Although the environment of FIG. 7 depicts four (4) hypervisors, each hosting one or more separate virtual severs, practical embodiments may include any number of hypervisors, virtual servers, and corresponding property information.

In one embodiment, each of the microservices comprising the security service 706 is a software “container,” where a container is an isolated user space instance within a virtualization environment in which the kernel of an operating system allows for the existence of multiple isolated user-space instances. In other embodiments, each of the microservices of security service 706 may represent a different type of virtual machine instance, a thread of execution, a standalone software application, or any other type of computing module.

### 3.0. FUNCTIONAL OVERVIEW

Approaches, techniques, and mechanisms are disclosed that enable a network security application to more efficiently deploy security profiles to virtual servers managed by the network security application. For example, the approaches described herein may be used to improve a network security application's ability to deploy security profiles whenever new virtual servers with varying security requirements are created at hypervisors running within a computing environment. In this context, a security profile generally refers to a set of security policy configurations, settings, values, etc., related to various functions of a virtual server including, for example, to which networks a virtual server is permitted to access, security configurations for applications running on the server, user permissions, encryption policies, etc. For example, the security profiles may be used to configure virtual servers in a system, such as the system described in Section 2.0, as new virtual servers are created at hypervisors 720, 730, 740 and 750 in response to increased needs for particular types of computing resources or for any other purposes. As illustrated in FIG. 7, for example, a policy configuration microservice 710 may be a component of a security service 706, where the policy configuration microservice is a single microservice among a possible plurality of other microservices running within the security service 706.

3.1. Security Profiles Overview

A modern data center often comprises many hypervisors collectively hosting anywhere from a few to thousands of separate virtual servers at any given time. Furthermore, the number of active virtual servers within many data centers often changes over time, with virtual servers being added or removed in response to changing workloads, load balancing efforts, and for other purposes. When a new virtual server is created in a data center, the virtual server typically is configured with various security options in order to protect the virtual server from security threats. For example, in some systems a menu or interactive guide may assist a system administrator with configuring various security options related to the new virtual server, or a system administrator may configure security settings for each new virtual server manually. In these and other similar environments, the ability to deploy new virtual servers may be limited by the amount of time it takes a system administrator or other user to manually configure the security settings for each new virtual server.

One approach for expediting the process of configuring security settings on newly created virtual servers and other computing resources is to create reusable security profiles. At a high level, a security profile includes a pre-defined set of security settings specifying various permissions and restrictions for a virtual server during operation. For example, a security profile may specify one or more network restrictions and permissions, operating system settings, application software settings, user access settings, etc. If a data center includes a large number of virtual servers that are substantially identical in terms of security requirements, a system administrator might define a security policy once and copy the defined security policy to each new virtual server as needed. However, some computing environments may include many different types of virtual servers, where each different type of virtual server performs a different type of workload and is therefore associated with a different set of security attributes.

According to embodiments described herein, security profiles are automatically and dynamically deployed to newly created virtual servers in a computing environment by profiling a population of existing virtual servers, identifying one or more existing virtual servers most similar to each newly created virtual server, and deploying a security profile associated with a closest matching virtual server to newly created virtual servers. As one high level example, consider a data center which includes several existing virtual servers configured with various applications for video editing among other virtual servers configured for other purposes. According to an embodiment, a security service generates server profile data for the existing population of virtual servers including the video editing virtual servers. Due to an increased need for video editing resources, a number of additional virtual servers configured for video editing may be created. In response to detecting the creation of several new virtual servers with the same applications for video editing, the same network permissions, and with the same user permissions, the security service can deploy to the new virtual servers a same security policy associated with the similar existing virtual servers without administrator involvement.

3.2. Profiling a Population of Existing Virtual Servers

As indicated above, a process for automatically deploying security profiles to newly created virtual servers may include profiling a population of existing virtual servers in a computing environment. In one embodiment, profiling a population of existing virtual servers includes generating server profile data indicating, for each existing virtual server, values for a plurality of properties associated with each of existing virtual servers. For example, for each of the existing virtual servers, a security service may determine a set of users permitted to access the virtual server, a set of networks to which the virtual server has access, a set of applications installed on the virtual server, a type and version of operating system installed on the virtual server, a security patch level of the virtual server, among other possible properties.

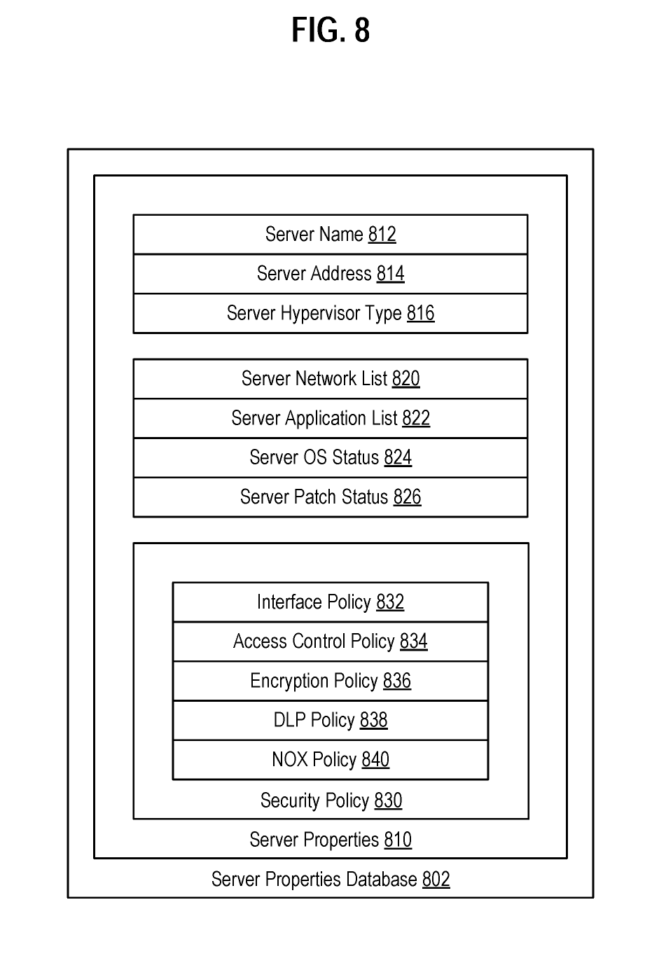

FIG. 8 depicts an embodiment of a server properties database. This database may be used to store server profile data for a population of virtual servers. For example, a server properties database 802 may include server properties entries (e.g., a server property entry 810), where each server properties entry stores values for various properties associated with a virtual server of a population of virtual servers. As depicted in the example of FIG. 8, each server properties entry may include a server name 812, a server address 814, a server hypervisor type 816, a server network list 820, a server application list 822, a server OS status 824, a server patch status 826, and a security policy 830. The set of server properties depicted in FIG. 8 are provided for illustrative purposes only; other embodiments may include a different set of server properties used to profile a population of virtual servers.

In an embodiment, a server name 812, server address 814, and a server hypervisor type 816 represent basic identification information for a virtual server to which a corresponding server properties entry relates. For example, a server name 812 may store a human readable label for the virtual server (e.g., corresponding to a hostname, device alias, or other label), a server address 814 may store an IP address or other type of address for the virtual server, and a server hypervisor type 816 may store information identifying a type of hypervisor on which the virtual server is hosted. These types of identification information may be obtained, for example, by querying the virtual server, the hypervisor hosting the virtual server, and/or another system component storing the information.

In an embodiment, a server network list 820, server application list 822, server OS status 824, and server patch status 826 represent other profile information about each virtual server. For example, a server network list 820 may store a set of specific IP addresses, IP address ranges, domain identifiers longest prefix matches, or other identifiers indicating which networks the corresponding virtual server has permission to access. A server application list 822 may store information identifying a set of applications that the virtual server has installed and/or are running on the server. For example, a server application list may include identifiers of particular applications and application versions running and/or installed on the virtual server, or may include more generic identifiers of applications on the virtual server (e.g., a web server, video editing software, etc.).

In an embodiment, a server properties entry 810 may further include a security policy 830. In general, a security policy 830 may include any number of different security policy settings. For example, a security policy 830 may include an interface policy 832 indicating whether the associated virtual server is configured to passively monitor, actively tap, or intercept network communications sent and/or received by the server. As another example, a security policy 830 may include an access control policy 834 specifying a set of networks to which the associated virtual server is permitted to access, types of network traffic permitted by the virtual server, users permitted to access the virtual server, etc. As yet another example, an encryption policy 836 may specify whether encryption is required or restricted for certain types of network connections.

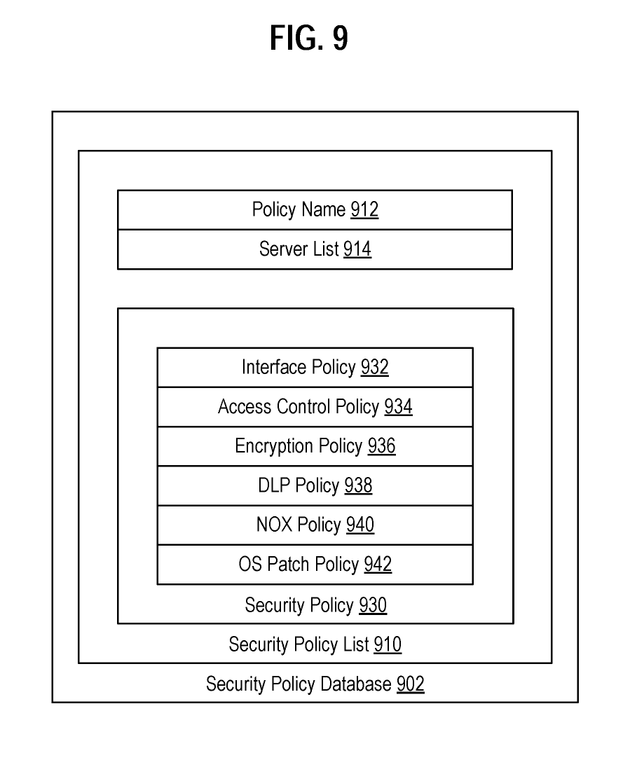

In an embodiment, in addition to storing profile information for existing virtual servers, a security service may further store information for each type of security profile used by one or more virtual servers in a computing environment. FIG. 9 depicts an example of a security policy database. In an embodiment, a security policy database 902 comprises a security policy list 910 including one or more security policy profiles (e.g., security policy profile 930). In FIG. 9, each security policy profile 930 comprises a policy name 912 (e.g., specifying a human readable label for the corresponding security policy profile) and a server list 914, which specifies any servers at which the corresponding security policy currently is deployed. A server list 914 may be used, for example, in instances where a particular security policy is updated so that servers associated with the same security policy can also be updated. A security policy profile 930 further includes configuration information for various aspects of a security policy such as, for example, an interface policy 932, an access control policy 934, an encryption policy 936, a DLP policy 938, a NOX policy 940, and an OS patch policy 942.

An exemplary advantage of identifying security policy 830 with server information that includes server OS status 824 and server patch status 826 is the ability to apply different security policy depending on patch status for both the OS and the applications. It is typical for a security vulnerability to be identified and subsequently patched but for some time to transpire before all affected systems can deploy the patch. This can occur for a number of reasons including the requirement to schedule downtime to apply the patch (and perhaps reboot). Similarly, an organization utilizing an application during a critical phase may want to complete a project before updating to a more secure version. Embodiments detailed herein allow for different security policies to be recorded based on the status of each server and for scaled-out versions of a particular server to identify peers with the most appropriate existing security policy.

3.3. Deploying Security Profiles Based on Server Profile Data

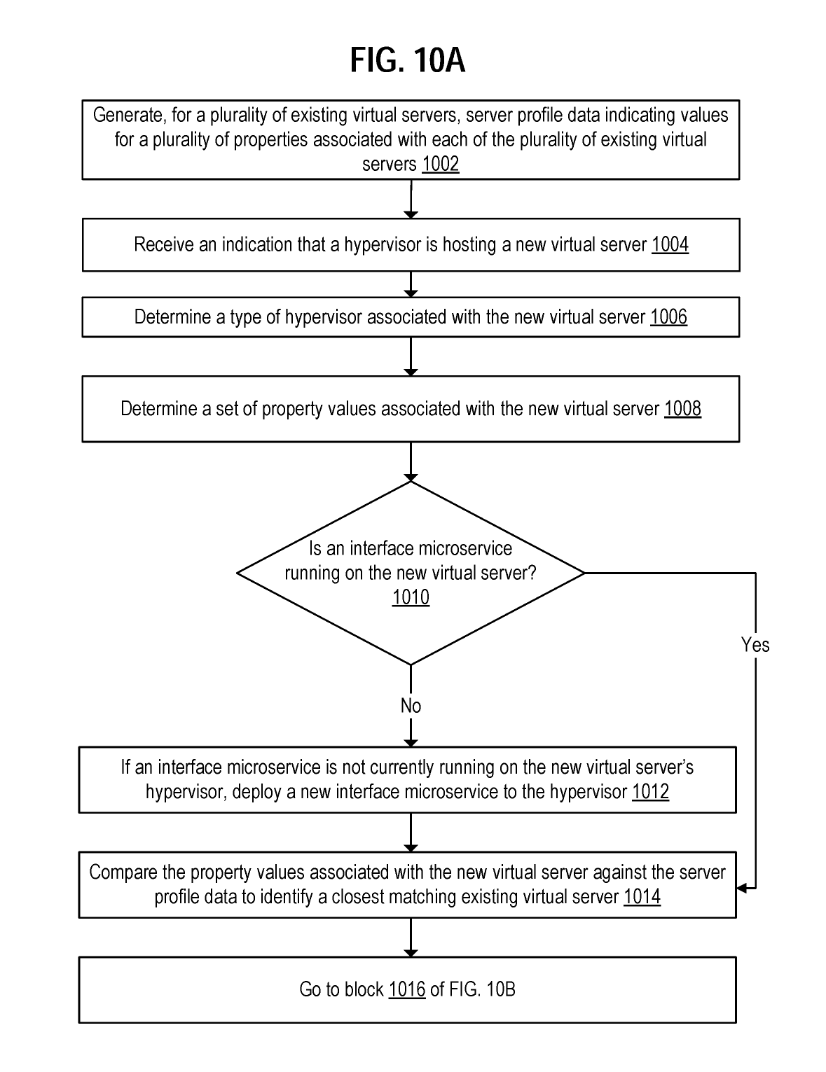

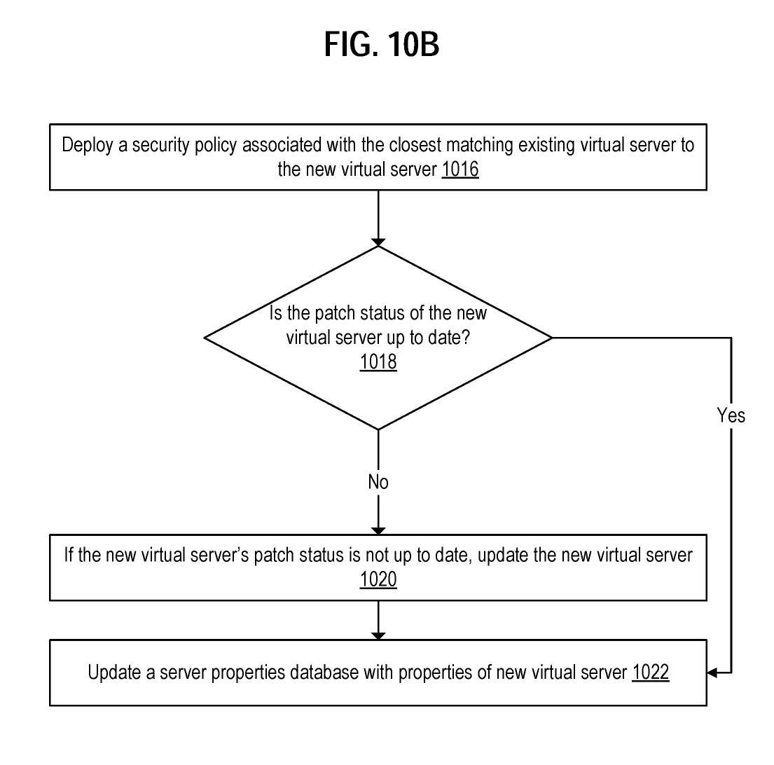

FIG. 10A is a flow diagram illustrating an embodiment of a method for a policy configuration microservice deploying security policies based on profile data for an existing population of virtual servers. At block 1002, server profile data is generated for a plurality of existing virtual servers, where the server profile data indicates values for a plurality of properties associated with each of the plurality of existing virtual servers. For example, a policy configuration microservice 710 may generate the server profile data for a set of virtual servers running on hypervisors (e.g., hypervisors 720-752). As described above in Section 3.2., a policy configuration microservice 710 may generate the server profile data by querying or retrieving the information from each of the existing virtual servers, from the hypervisors upon which the virtual servers are running, from a separate data source containing the profile data, or from any other source to generate the server profile data.

At block 1004, the policy configuration microservice receives an indication that a hypervisor is hosting a new virtual server, the new virtual server associated with a plurality of property values. For example, a policy configuration microservice 710 may receive a notification, alert, or other type of message from one of hypervisors 720, 730, 740 and 750 indicating that the new virtual server is created. The indication of the new virtual server may include one or more property values associated with the new virtual server (e.g., the indication may specify at which hypervisor the new virtual server is running, an operating system running on the virtual server, etc.).

At block 1006, a type of hypervisor associated with the new virtual server is determined. For example, a policy configuration microservice 710 may determine a type of hypervisor associated with a new virtual server based on information included in the message indicating the creation of the new virtual server, or a type of hypervisor may be determined based on querying the hypervisor, the new virtual server, or obtaining the information from any other data source.

At block 1008, a set of property values associated with the new virtual server is determined. For example, a policy configuration microservice 710 may determine one or more property values associated with the new virtual server from the message indicating the creation of the new virtual server, by querying or retrieving the information from the new virtual server, from the hypervisor hosting the new virtual server, or from another data source. In an embodiment, determining a set of property values associated with the new virtual server may include determining, among other data items, a server network list (e.g., a list of servers and/or networks to which the new virtual server can access), a server application list (e.g., indicating a list of applications running on the virtual server and associated application properties), server operating system (OS) information (e.g., indicating information about versioning and OS configuration settings), and a server patch status (e.g., indicating security patches currently applied to the virtual server).

At block 1010, it is determined whether an interface microservice is currently running on the new virtual server's hypervisor. For example, a policy configuration microservice 710 may determine whether an interface microservice (e.g., such as interface microservice 722 for the hypervisor 720) is running on the new server's hypervisor by determining whether the hypervisor responds to queries for information about the new virtual server, based on an explicit query checking for the existence of the interface microservice, or based on any other data source indicating whether an interface microservice currently is running on the hypervisor. If an interface microservice is not currently running on the new virtual server's hypervisor, an interface microservice is deployed to the hypervisor at block 1012. Otherwise, if an interface microservice is currently running on the new virtual server's hypervisor, then this existing interface microservice is subsequently utilized and the process proceeds to block 1014.

At block 1014, the property values determined for the new virtual server are compared against the generated server profile data for the existing population of virtual servers to identify one or more closest matching existing virtual servers. For example, a policy configuration microservice 710 may compare the property values determined at block 1008 against property values stored for a population of virtual servers in a server properties database 716. Determining the closest matching server may include, for example, finding one or more existing virtual servers stored in the server properties database 716 with the greatest number of matching properties, where the matched properties may include one or more of a type and version of operating system running on the virtual servers, a security patch level applied to the servers, networks to which the servers are permitted access, types and versions of applications running on the virtual servers, etc.

For example, a new virtual server may be created and determined to be running a version 9.5 of a particular type of operating system, determined to have access to networks A, B and E, associated with users in two specified user groups, and have installed a database server and applications for video editing. In this example, a policy configuration microservice 710 may compare each of these properties against similar properties of virtual servers stored in a server properties database 716 to find one or more existing virtual servers running a same operating system and version, having access to the same networks, permitting access by the same user groups, and having the same applications and versions installed. In some examples and for some properties, the matching may not be exact. For example, a policy configuration microservice 710 may compare a security patch level property value to locate virtual servers having at least the same patch level or newer. As another example, a policy configuration microservice 710 may be configured to search for existing virtual servers running a type of application within three versions of the same type of application running on a new virtual server (e.g., if a new virtual server is running a newest version web server 5.0, the microservice may match existing virtual servers running web servers with versions 2.0 through 5.0). In general, the type of matching performed for each property may be customized by an administrator or other user of the system.

As an example of identifying a closest matching existing virtual server, different metrics may be examined and compared to identify the most suitable match. In general terms, the most suitable match of a security policy is an existing policy that is least restrictive yet meets or exceeds the security requirements of the new server. For properties such as a server's operating system, security policies from existing servers with the same operating system may be considered if the server's patch status is at or beyond that of the existing server. The new server's application list may be considered by evaluating the installed applications on the new server to be a subset of those of an existing server with an existing security policy. The new server's network list may be considered by evaluating the active networks connections on the new server to be within the subnets of those present of an existing server with an existing security policy.

Determining a closest match may include a number of mathematical processes such as clustering (determining a distance metric from each existing server and selecting the shortest distance), calculating a weighting of certain properties, masking (requiring an exact match) certain properties, or any other methods, including combinations of multiple methods. In some embodiments, automatic assignment of a security policy is dependent on the degree of match found (such as the magnitude of a distance metric) such that the new server is not assigned a policy without administrator intervention if the distance metric is greater than some specified threshold. Based on the identified closest matching existing virtual server at block 1014, the flow diagram of FIG. 10A proceeds to block 1016 of FIG. 10B.

Referring to FIG. 10B, at block 1016, a security policy associated with the closest matching existing virtual server is deployed to the new virtual server. For example, based on identifying one or more closest matching existing virtual servers at block 1014, a policy configuration microservice 710 may determine a particular security policy associated with the closest matching server(s) (e.g., by looking up the existing virtual server's security policy from the security policy database 712). A policy configuration microservice 710 may deploy the security policy to the new virtual server by sending the security policy configuration information to the new virtual server, sending to the hypervisor running the new virtual server, or to any other application capable of configuring the new virtual server with the security settings specified in the selected security profile.

At block 1018, it is determined whether the new virtual server's operating system and/or application patch status is out of date. If the new virtual server's operating system and/or application patch status is not up to date, then at block 1020, the new virtual server is updated. For example, the policy configuration microservice 710 may be configured to detect if there are existing virtual servers with a same operating system and/or same application(s), but that have a security patch level above that the currently applied to the newly created virtual server. In response to detecting the existence of a more current security patch level, the policy configuration microservice may cause the newly deployed machine to apply the more current security patch. Based on updating the new virtual server, or if the current patch status is determined to be up to date at block 1018, the flow diagram of FIG. 10B proceeds to block 1022.

At block 1022, a server properties database is updated to include the properties associated with the new virtual server. For example, the policy configuration microservice 710 may update the server properties database 716 with information for the new virtual server. The property information, for example, may include the information determined at block 1008 and may include any other additional information known about the new virtual server. By storing the property information for the new virtual server in the server properties database 716, information about the new virtual server can be used to inform security policy selections for subsequently created virtual servers. In this manner, the example process described in FIGS. 10A-10B can be repeated any number of times, and the information used to automatically select an appropriate security policy for new virtual servers is updated over time. Furthermore, if security policy information for one or more virtual servers is updated during operation (e.g., in response to application of a new security patch, in response to one or more configuration changes by a system administrator or other user, etc.), this information can be added to the security policy data and used in subsequent security policy selections.

### 4.0. EXAMPLE EMBODIMENTS

Examples of some embodiments are represented, without limitation, by the following:

In an embodiment, a method or non-transitory computer readable medium comprises: generating, for a plurality of existing virtual servers, server profile data indicating values for a plurality of properties associated with each of the plurality of existing virtual servers; receiving an indication that a hypervisor is hosting a new virtual server associated having a plurality of property values; in response to receiving the indication, comparing the property values associated with the new virtual server against the server profile data to identify a closest matching existing virtual server, wherein the closest matching existing virtual server is associated with a security policy from a plurality of stored security policies; deploying the security policy associated with the closest matching existing virtual server to the new virtual server.

In an embodiment, a method or non-transitory computer readable medium comprises: wherein the server profile data indicates, for each existing virtual server of the plurality of existing virtual servers, a set of networks to which the existing virtual server is permitted to access.

In an embodiment, a method or non-transitory computer readable medium comprises: wherein the server profile data indicates, for each existing virtual server of the plurality of existing virtual servers, a set of computer applications hosted by the existing virtual server.

In an embodiment, a method or non-transitory computer readable medium comprises: wherein the server profile data indicates, for each existing virtual server of the plurality of existing virtual servers, a type of hypervisor hosting the existing virtual server.

In an embodiment, a method or non-transitory computer readable medium comprises: wherein the server profile data indicates, for each existing virtual server of the plurality of existing virtual servers, an operating system version running on the existing virtual server.

In an embodiment, a method or non-transitory computer readable medium comprises: wherein the server profile data indicates, for each existing virtual server of the plurality of existing virtual servers, a software patch status associated with one or more computer applications hosted by the existing virtual server.

In an embodiment, a method or non-transitory computer readable medium comprises: wherein comparing the property values associated with the new virtual server against the server profile data includes identifying one or more existing virtual servers running a same operating system and having a same or older software patch status.

In an embodiment, a method or non-transitory computer readable medium comprises: wherein deploying the security policy to the new virtual server comprises sending the security policy to the new virtual server.

In an embodiment, a method or non-transitory computer readable medium comprises: wherein deploying the security policy to the new virtual server comprises sending a reference to the security policy.

In an embodiment, a method or non-transitory computer readable medium comprises: wherein the security policy specifies configurations related to one or more of an interface policy, an access control policy, an encryption policy, a data loss prevention (DLP) policy.

Other examples of these and other embodiments are found throughout this disclosure.

### 5.0. IMPLEMENTATION MECHANISM—HARDWARE OVERVIEW

According to one embodiment, the techniques described herein are implemented by one or more special-purpose computing devices. The special-purpose computing devices may be desktop computer systems, portable computer systems, handheld devices, networking devices or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

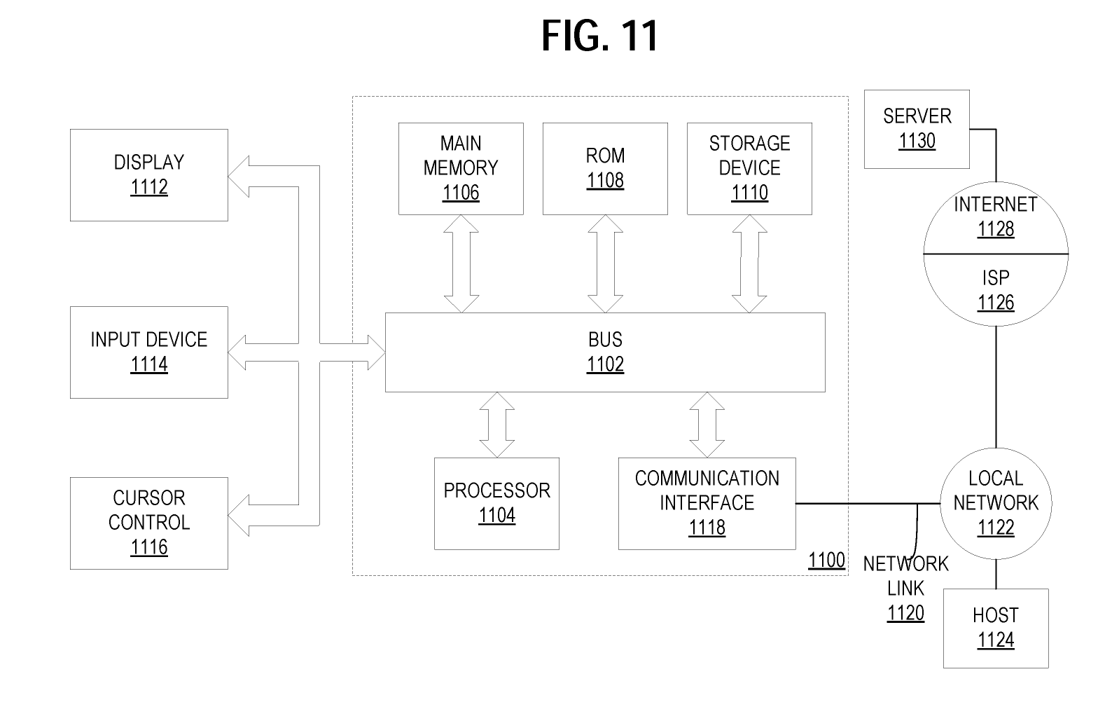

FIG. 11 is a block diagram that illustrates a computer system 1100 utilized in implementing the above-described techniques, according to an embodiment. Computer system 1100 may be, for example, a desktop computing device, laptop computing device, tablet, smartphone, server appliance, computing mainframe, multimedia device, handheld device, networking apparatus, or any other suitable device.

Computer system 1100 includes one or more buses 1102 or other communication mechanism for communicating information, and one or more hardware processors 1104 coupled with buses 1102 for processing information. Hardware processors 1104 may be, for example, general purpose microprocessors. Buses 1102 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 1100 also includes a main memory 1106, such as a random access memory (RAM) or other dynamic or volatile storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 a special-purpose machine that is customized to perform the operations specified in the instructions.

Computer system 1100 further includes one or more read only memories (ROM) 1108 or other static storage devices coupled to bus 1102 for storing static information and instructions for processor 1104. One or more storage devices 1110, such as a solid-state drive (SSD), magnetic disk, optical disk, or other suitable non-volatile storage device, is provided and coupled to bus 1102 for storing information and instructions.

Computer system 1100 may be coupled via bus 1102 to one or more displays 1112 for presenting information to a computer user. For instance, computer system 1100 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 1112 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 1112.

One or more input devices 1114 are coupled to bus 1102 for communicating information and command selections to processor 1104. One example of an input device 1114 is a keyboard, including alphanumeric and other keys. Another type of user input device 1114 is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane. Yet other examples of suitable input devices 1114 include a touch-screen panel affixed to a display 1112, cameras, microphones, accelerometers, motion detectors, and/or other sensors. In an embodiment, a network-based input device 1114 may be utilized. In such an embodiment, user input and/or other information or commands may be relayed via routers and/or switches on a Local Area Network (LAN) or other suitable shared network, or via a peer-to-peer network, from the input device 1114 to a network link 1120 on the computer system 1100.

A computer system 1100 may implement techniques described herein using customized hard-wired logic circuitry, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or a solid state drive of a remote computer. The remote computer can load the instructions into its dynamic memory and use a modem to send the instructions over a network, such as a cable network or cellular network, as modulate signals. A modem local to computer system 1100 can receive the data on the network and demodulate the signal to decode the transmitted instructions. Appropriate circuitry can then place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

A computer system 1100 may also include, in an embodiment, one or more communication interfaces 1118 coupled to bus 1102. A communication interface 1118 provides a data communication coupling, typically two-way, to a network link 1120 that is connected to a local network 1122. For example, a communication interface 1118 may be an integrated services digital network (ISDN) card, cable modem, satellite modem, or a modem to provide a data communication connection to a corresponding type of telephone line. As another example, the one or more communication interfaces 1118 may include a local area network (LAN) card to provide a data communication connection to a compatible LAN. As yet another example, the one or more communication interfaces 1118 may include a wireless network interface controller, such as a 802.11-based controller, Bluetooth controller, Long Term Evolution (LTE) modem, and/or other types of wireless interfaces. In any such implementation, communication interface 1118 sends and receives electrical, electromagnetic, or optical signals that carry digital data streams representing various types of information.

Network link 1120 typically provides data communication through one or more networks to other data devices. For example, network link 1120 may provide a connection through local network 1122 to a host computer 1124 or to data equipment operated by a Service Provider 1126. Service Provider 1126, which may for example be an Internet Service Provider (ISP), in turn provides data communication services through a wide area network, such as the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

In an embodiment, computer system 1100 can send messages and receive data, including program code and/or other types of instructions, through the network(s), network link 1120, and communication interface 1118. In the Internet example, a server 1130 might transmit a requested code for an application program through Internet 1128, ISP 1126, local network 1122 and communication interface 1118. The received code may be executed by processor 1104 as it is received, and/or stored in storage device 1110, or other non-volatile storage for later execution. As another example, information received via a network link 1120 may be interpreted and/or processed by a software component of the computer system 1100, such as a web browser, application, or server, which in turn issues instructions based thereon to a processor 1104, possibly via an operating system and/or other intermediate layers of software components.

In an embodiment, some or all of the systems described herein may be or comprise server computer systems, including one or more computer systems 1100 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. EXTENSIONS AND ALTERNATIVES

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method, comprising:
generating, for a plurality of existing virtual servers, server profile data indicating values for a plurality of properties associated with each of the plurality of existing virtual servers;
receiving an indication that a hypervisor is hosting a new virtual server associated with a plurality of property values;
in response to receiving the indication, comparing the property values associated with the new virtual server against the server profile data to identify a closest matching existing virtual server, wherein the closest matching existing virtual server is associated with a security policy from a plurality of stored security policies;
deploying the security policy associated with the closest matching existing virtual server to the new virtual server.

2. The method of claim 1, wherein the server profile data indicates, for each existing virtual server of the plurality of existing virtual servers, a set of networks to which the existing virtual server is permitted to access.

3. The method of claim 1, wherein the server profile data indicates, for each existing virtual server of the plurality of existing virtual servers, a set of computer applications hosted by the existing virtual server.

4. The method of claim 1, wherein the server profile data indicates, for each existing virtual server of the plurality of existing virtual servers, a type of hypervisor hosting the existing virtual server.

5. The method of claim 1, wherein the server profile data indicates, for each existing virtual server of the plurality of existing virtual servers, an operating system version running on the existing virtual server.

6. The method of claim 1, wherein the server profile data indicates, for each existing virtual server of the plurality of existing virtual servers, a software patch status associated with one or more computer applications hosted by the existing virtual server.

7. The method of claim 1, wherein comparing the property values associated with the new virtual server against the server profile data includes identifying one or more existing virtual servers running a same operating system and having a same or older software patch status.

8. The method of claim 1, wherein deploying the security policy to the new virtual server comprises sending the security policy to the new virtual server.

9. The method of claim 1, wherein deploying the security policy to the new virtual server comprises sending a reference to the security policy.

10. The method of claim 1, wherein the security policy specifies configurations related to one or more of an interface policy, an access control policy, an encryption policy, a data loss prevention policy.

11. A non-transitory computer-readable storage medium storing instructions which, when executed by one or more processors, cause performance of operations comprising:
generating, for a plurality of existing virtual servers, server profile data indicating values for a plurality of properties associated with each of the plurality of existing virtual servers;
receiving an indication that a hypervisor is hosting a new virtual server associated with a plurality of property values;
in response to receiving the indication, comparing the property values associated with the new virtual server against the server profile data to identify a closest matching existing virtual server, wherein the closest matching existing virtual server is associated with a security policy from a plurality of stored security policies;
deploying the security policy associated with the closest matching existing virtual server to the new virtual server.

12. The non-transitory computer-readable storage medium of claim 11, wherein the server profile data indicates, for each existing virtual server of the plurality of existing virtual servers, a set of networks to which the existing virtual server is permitted to access.

13. The non-transitory computer-readable storage medium of claim 11, wherein the server profile data indicates, for each existing virtual server of the plurality of existing virtual servers, a set of computer applications hosted by the existing virtual server.

14. The non-transitory computer-readable storage medium of claim 11, wherein the server profile data indicates, for each existing virtual server of the plurality of existing virtual servers, a type of hypervisor hosting the existing virtual server.

15. The non-transitory computer-readable storage medium of claim 11, wherein the server profile data indicates, for each existing virtual server of the plurality of existing virtual servers, an operating system version running on the existing virtual server.

16. The non-transitory computer-readable storage medium of claim 11, wherein the server profile data indicates, for each existing virtual server of the plurality of existing virtual servers, a software patch status associated with one or more computer applications hosted by the existing virtual server.

17. The non-transitory computer-readable storage medium of claim 11, wherein comparing the property values associated with the new virtual server against the server profile data includes identifying one or more existing virtual servers running a same operating system and having a same or older software patch status.

18. The non-transitory computer-readable storage medium of claim 11, wherein deploying the security policy to the new virtual server comprises sending the security policy to the new virtual server.

19. The non-transitory computer-readable storage medium of claim 11, wherein deploying the security policy to the new virtual server comprises sending a reference to the security policy.

20. The non-transitory computer-readable storage medium of claim 11, wherein the security policy specifies configurations related to one or more of an interface policy, an access control policy, an encryption policy, a data loss prevention policy.

21. An apparatus, comprising:
one or more processors;
a non-transitory computer-readable storage medium coupled to the one or more processors, the computer-readable storage medium storing instructions which, when executed by the one or more processors, causes the apparatus to:
generate, for a plurality of existing virtual servers, server profile data indicating values for a plurality of properties associated with each of the plurality of existing virtual servers;
receive an indication that a hypervisor is hosting a new virtual server associated with a plurality of property values;
in response to receiving the indication, compare the property values associated with the new virtual server against the server profile data to identify a closest matching existing virtual server, wherein the closest matching existing virtual server is associated with a security policy from a plurality of stored security policies;
deploy the security policy associated with the closest matching existing virtual server to the new virtual server.

22. The apparatus of claim 21, wherein the server profile data indicates, for each existing virtual server of the plurality of existing virtual servers, a set of networks to which the existing virtual server is permitted to access.

23. The apparatus of claim 21, wherein the server profile data indicates, for each existing virtual server of the plurality of existing virtual servers, a set of computer applications hosted by the existing virtual server.

24. The apparatus of claim 21, wherein the server profile data indicates, for each existing virtual server of the plurality of existing virtual servers, a type of hypervisor hosting the existing virtual server.

25. The apparatus of claim 21, wherein the server profile data indicates, for each existing virtual server of the plurality of existing virtual servers, an operating system version running on the existing virtual server.

26. The apparatus of claim 21, wherein the server profile data indicates, for each existing virtual server of the plurality of existing virtual servers, a software patch status associated with one or more computer applications hosted by the existing virtual server.

27. The apparatus of claim 21, wherein comparing the property values associated with the new virtual server against the server profile data includes identifying one or more existing virtual servers running a same operating system and having a same or older software patch status.

28. The apparatus of claim 21, wherein deploying the security policy to the new virtual server comprises sending the security policy to the new virtual server.

29. The apparatus of claim 21, wherein deploying the security policy to the new virtual server comprises sending a reference to the security policy.

30. The apparatus of claim 21, wherein the security policy specifies configurations related to one or more of an interface policy, an access control policy, an encryption policy, a data loss prevention policy.
